(19) United States
(12) Patent Application Publication
(10) Pub. No.: US 2019/0072091 A1
(43) Pub. Date: Mar. 7, 2019

(54) VANE PUMP

(71) Applicant: KYB Corporation, Tokyo (JP)

(72) Inventors: Yoshiyuki MAKI, Aichi (JP); Tomoyuki NAKAGAWA, Gifu (JP); Masamichi SUGIHARA, Gifu (JP)

(73) Assignee: KYB Corporation, Tokyo (JP)

(21) Appl. No.: 15/767,215

(22) PCT Filed: Sep. 20, 2016
(86) PCT No.: PCT/JP2016/077691

§ 371 Date: Apr. 10, 2018

(30) Foreign Application Priority Data
Oct. 21, 2015 (JP) 2015-206951

(51) Int. Cl. F04C 15/06; F04C 2/344

(52) U.S. Cl. CPC F04C 15/06; F04C 2/344; F05B 2240/14; F04C 2250/101; F05B 2250/501; F04C 2210/206

(57) ABSTRACT

A vane pump includes a rotor that is rotationally driven; vanes inserted into the rotor in a freely slidable manner; pump chambers that are defined between the vanes at adjacent positions; suction ports that guide working oil to the pump chambers; suction pressure chamber that is communicated with the suction ports and that stores the working oil; and a suction passage that is connected to the suction pressure chamber and that has an suction opening end that opens at an outer surface of a pump body. In a state in which the vane pump is mounted, the suction pressure chamber is mounted below the suction opening end of the suction passage.

### TECHNICAL FIELD

The present invention relates to a vane pump.

### BACKGROUND ART

JP2013-087751A describes a vane pump that includes a rotor formed with a plurality of slits extending in the radiating direction and a plurality of vanes that are accommodated into the respective slits in a freely slidable manner. Tip-end surfaces of the vanes are brought into sliding contact with a cam face of a cam ring. Working oil in a tank is guided into the vane pump through an suction inlet opening downwards.

### SUMMARY OF INVENTION

Because the vane pump described in JP2013-087751A is normally arranged within the tank, passages in the pump are filled with the working oil. However, in a state in which the pump cannot be arranged within the tank due to a limited space and the pump is arranged outside the tank, the working oil in the pump returns to the tank through the suction inlet after the pump is stopped. Therefore, there is a risk in that a buildup of the discharge pressure is delayed when the pump is driven again.

An object of the present invention is to improve a buildup of discharge pressure in the vane pump regardless of the mounting position.

According to one aspect of the present invention, a vane pump used as a fluid pressure source is provided. The vane pump includes: a rotor configured to be driven rotationally; a plurality of vanes inserted into the rotor in a freely slidable manner; a cam ring with which tip-end portions of the vanes are brought into sliding contact with rotation of the rotor; a pump body configured to accommodate the cam ring; a pump cover configured to seal the pump body; pump chambers defined between the vanes at adjacent positions and the cam ring; a suction port configured to guide working fluid to the pump chambers; a storage chamber configured to store the working fluid, the storage chamber being configured to communicate with the suction port; and a suction passage configured to have a connection portion and a suction opening end, the connection portion being connected to the storage chamber and the suction opening end being configured to open at an outer surface of the pump body. The storage chamber is provided below the suction opening end of the suction passage in a state in which the vane pump is mounted.

### BRIEF DESCRIPTION OF DRAWINGS

FIG. 1 is a sectional view of a vane pump according to an embodiment of the present invention.

FIG. 2 is a sectional view taken along a line II-II in FIG. 1.

FIG. 3 is a sectional view taken along a line III-III in FIG. 1.

FIG. 4 is a sectional view taken along a line IV-IV in FIG. 1.

FIG. 5 is a sectional view taken along a line V-V in FIG. 3.

FIG. 6 is a sectional view taken along a line VI-VI in FIG. 3.

### DESCRIPTION OF EMBODIMENTS

A vane pump 100 according to an embodiment of the present invention will be described below with reference to the drawings.

The vane pump 100 is arranged outside a tank for storing working fluid, and the vane pump 100 is used as a fluid pressure source for supplying the pressurized working fluid to a fluid hydraulic apparatus mounted on a vehicle etc., such as, for example, a power steering apparatus, a continuously variable transmission, or the like. Working oil, aqueous alternative fluid of other type, or the like may be used as the working fluid.

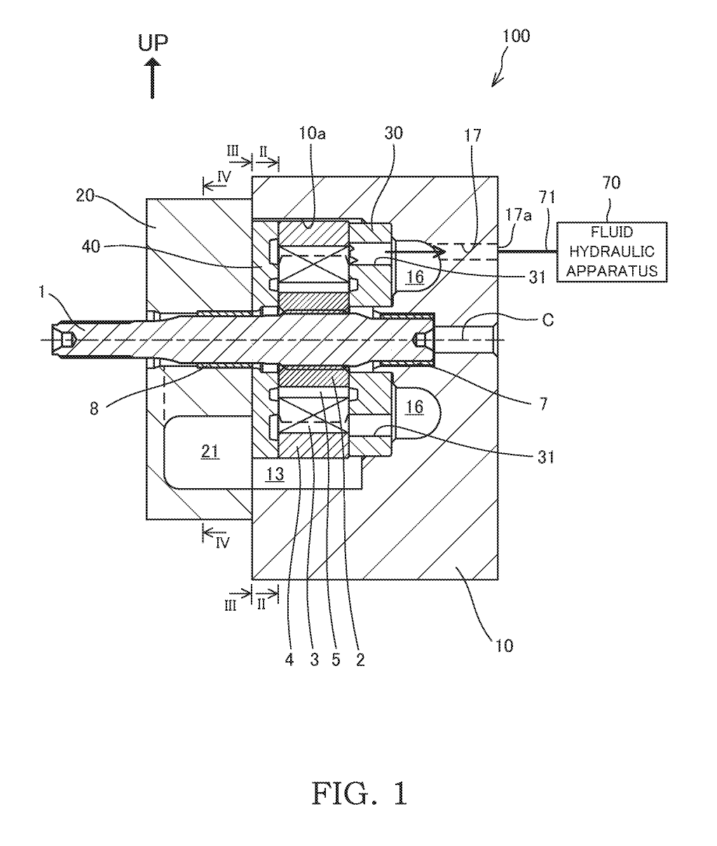

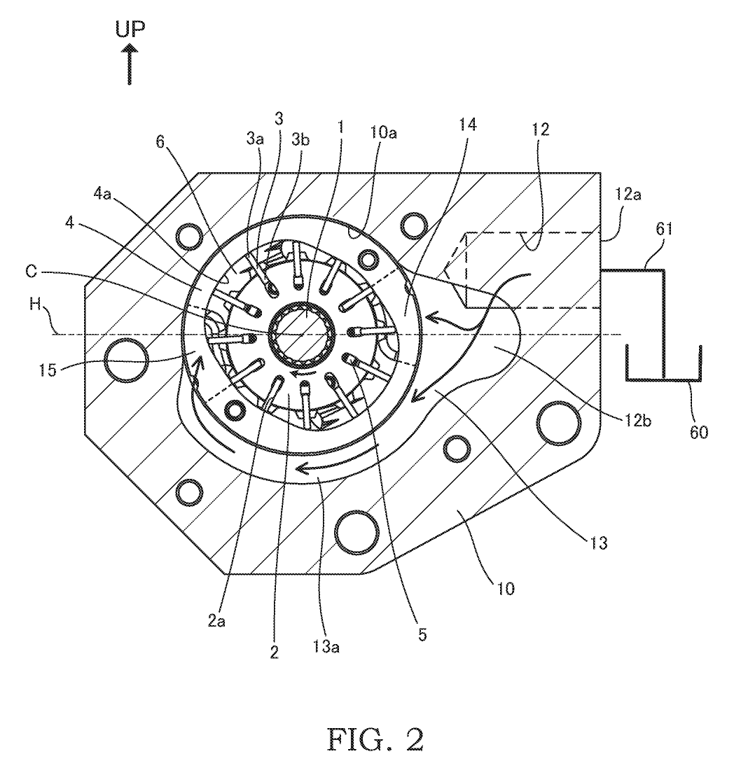

As shown in FIGS. 1 and 2, the vane pump 100 includes a pump body 10 formed with a pump accommodating concave portion 10a, a pump cover 20 that covers the pump accommodating concave portion 10a and that is fixed to the pump body 10, a driving shaft 1 that is rotatably supported by the pump body 10 and the pump cover 20 via bearings 7 and 8, a rotor 2 that is linked to the driving shaft 1 and accommodated in the pump accommodating concave portion 10a, a plurality of slits 2a that open at an outer circumference of the rotor 2 so as to extend in a radiating pattern, vanes 3 that are received in the respective slits 2a in a freely slidable manner, and a cam ring 4 accommodating the rotor 2 and the vanes 3 and having an inner circumference cam face 4a on which tip-end portions 3a of the vanes 3 are brought into sliding contact.

The vane pump 100 is driven by, for example, an engine (not shown), etc., and fluid pressure is generated as the rotor 2 linked to the driving shaft 1 is rotationally driven in the clockwise direction as shown by an arrow in FIG. 2. The vane pump 100 is mounted to the fluid hydraulic apparatus, such as the power steering apparatus, the continuously variable transmission, or the like, or a driving source, such as the engine, an electric motor, or the like, such that the direction indicated as “UP” in FIGS. 1 to 4 becomes the vertically upwards direction.

The vanes 3 are respectively inserted into the slits 2a in a freely slidable manner, and the vanes 3 respectively have the tip-end portions 3a that are end portions positioned at the directions projecting out from the slits 2a and base-end portions 3b that are end portions positioned on the opposite sides of the tip-end portions 3a. On the bottom portion side of the slits 2a, back pressure chambers 5 into which the working oil serving as the working fluid is guided are formed by being defined by the base-end portions 3b of the vanes 3. The vanes 3 are pushed by the pressure in the back pressure chambers 5 in the directions in which the vanes 3 project out from the slits 2a.

The cam ring 4 is an annular member having the inner circumference cam face 4a serving as an inner circumferential surface having a substantially oval shape. As the vanes 3 are pushed in the directions projecting out from the slits 2a by the pressure in the back pressure chambers 5, the tip-end portions 3a of the vanes 3 are brought into sliding contact with the inner circumference cam face 4a of the cam ring 4. With such a configuration, pump chambers 6 are defined within the cam ring 4 by an outer circumferential surface of the rotor 2, the inner circumference cam face 4a of the cam ring 4, and two adjacent vanes 3.

Because the inner circumference cam face 4a of the cam ring 4 has the substantially oval shape, the displacement of the pump chambers 6, which are defined between the respective vanes 3 that slide at the inner circumference cam face 4a by rotation of the rotor 2, are repeatedly expanded and contracted. The working oil is sucked in suction regions where the pump chambers 6 are expanded, and the working oil is discharged in discharge regions where the pump chambers 6 are contracted.

As the rotor 2 completes a full rotation, the pump chambers 6 repeat the expansion and contraction twice. Although the vane pump 100 has two suction regions and two discharge regions, the configuration is not limited thereto, and the vane pump 100 may have one suction region or more than two suction regions and may have one discharge region or more than two discharge regions.

The vane pump 100 further includes a disk shaped body-side side plate 30 that is provided between a bottom surface of the pump accommodating concave portion 10a and the rotor 2 and a disk shaped cover-side side plate 40 that is provided between the rotor 2 and the pump cover 20. The body-side side plate 30 and the cover-side side plate 40 are arranged so as to be opposed to each other on both side surfaces of the rotor 2 and the cam ring 4. The cam ring 4 is brought into contact with the body-side side plate 30 and the cover-side side plate 40, and the rotor 2 is brought into sliding contact with the body-side side plate 30 and the cover-side side plate 40.

The body-side side plate 30 has discharge ports 31 to which the working oil to be discharged from the pump chambers 6 is guided, a first suction concave portion 32 that defines a first suction port 14 guiding the working oil to the pump chambers 6, and a second suction concave portion 33 that defines a second suction port 15 guiding the working oil to the pump chambers 6.

The discharge ports 31 are provided at two positions so as to be opposed to each other with respect to the rotation center C of the rotor 2. The discharge ports 31 are formed so as to penetrate through the body-side side plate 30, and thereby, the pump chambers 6 are communicated with a high-pressure chamber 16, which will be described later, formed in the pump body 10.

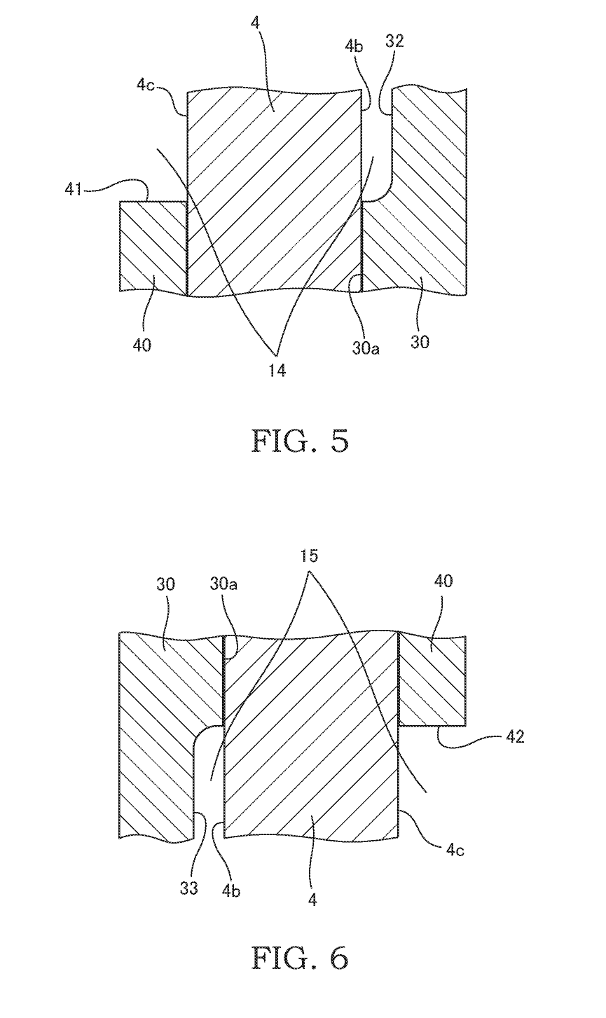

The first suction concave portion 32 and the second suction concave portion 33 are provided in a contact surface 30a that is brought into contact with the cam ring 4 so as to be opposed to each other with respect to the rotation center C of the rotor 2. As shown in FIGS. 5 and 6, the first suction concave portion 32 and the second suction concave portion 33 are formed to have a concave shape such that the one end thereof opens to the pump chambers 6 and the other end thereof opens to outer side of the body-side side plate 30 in the radial direction.

As shown in FIG. 5, together with an opposing body-side contact surface 4b of the cam ring 4, the first suction concave portion 32 defines the first suction port 14, and as shown in FIG. 6, together with the opposing body-side contact surface 4b of the cam ring 4, the second suction concave portion 33 defines the second suction port 15.

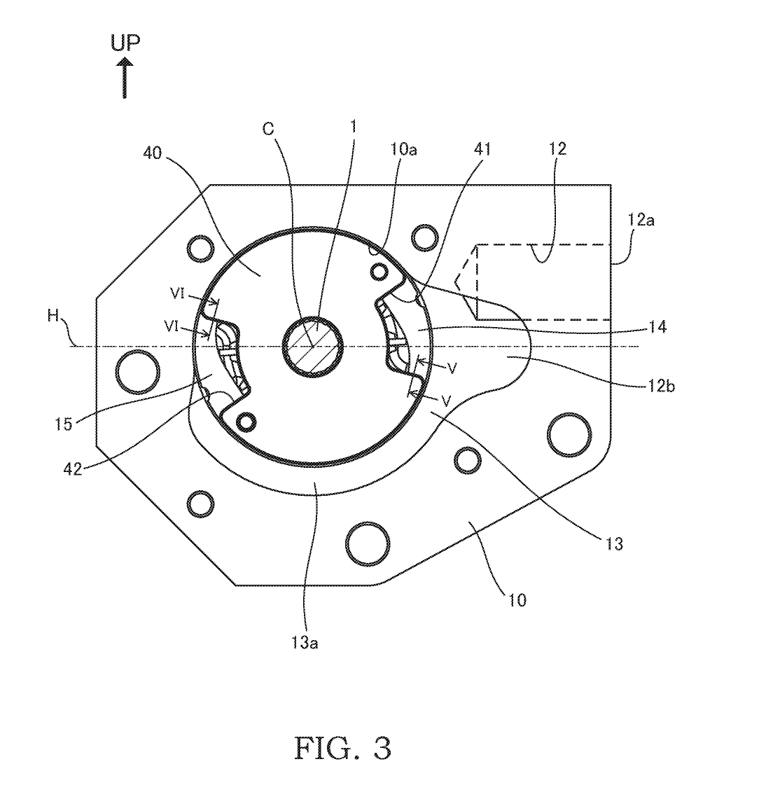

As shown in FIG. 3, the cover-side side plate 40 has a first suction cut-out portion 41 and a second suction cut-out portion 42 that are formed so as to cut out portions of an outer edge of the cover-side side plate 40. As shown in FIG. 5, together with an opposing cover-side contact surface 4c of the cam ring 4, the first suction cut-out portion 41 defines the first suction port 14, and as shown in FIG. 6, together with the opposing cover-side contact surface 4c of the cam ring 4, the second suction cut-out portion 42 defines the second suction port 15.

Through the first suction port 14 and the second suction port 15, which are defined by the cam ring 4, the body-side side plate 30, and the cover-side side plate 40, the pump chambers 6 are communicated with a suction pressure chamber 13, which will be described later. In a state in which the vane pump 100 is mounted on the fluid hydraulic apparatus, etc., the first suction port 14 and the second suction port 15 are arranged on the horizontal line H extending through the rotation center C of the rotor 2. In a state in which the vane pump 100 is mounted on the fluid hydraulic apparatus, etc., the first suction port 14 guides the working oil to the pump chambers 6 that are contracted below the rotation center C of the rotor 2 among the pump chambers 6, and the second suction port 15 guides the working fluid to the pump chambers 6 that are contracted above the rotation center C of the rotor 2 among the pump chambers 6.

By accommodating the body-side side plate 30, the rotor 2, the cam ring 4, and the cover-side side plate 40 in the pump accommodating concave portion 10a of the pump body 10 and by attaching the pump cover 20 to the pump body 10, the pump accommodating concave portion 10a is sealed.

The vane pump 100 further includes a suction passage 12 that has a suction opening end 12a opening at an outer surface of the pump body 10 and the suction pressure chamber 13 that is connected to the suction passage 12 through a connection portion 12b.

The suction opening end 12a is connected to the one end of a suction pipe 61, and the other end of the suction pipe 61 is connected to a tank 60. The working oil to be stored in the tank 60 through the suction pipe 61 is guided to the suction passage 12. In a state in which the vane pump 100 is mounted on the fluid hydraulic apparatus, etc., the suction opening end 12a of the suction passage 12 is provided so as to be positioned above the first suction port 14 and the second suction port 15.

The suction pressure chamber 13 is formed in the pump body 10, and the suction pressure chamber 13 functions as a storage chamber for storing the working oil to be sucked into the pump chambers 6 through the first suction port 14 and the second suction port 15. The suction pressure chamber 13 has a communication portion 13a through which the first suction port 14 is communicated with the second suction port 15. The suction pressure chamber 13 is communicated with the first suction port 14 at a portion closer to the connection portion 12b than the portion where the suction pressure chamber 13 is communicated with the second suction port 15. Therefore, when the vane pump 100 is driven, the working oil is supplied to the first suction port 14 with priority relative to the second suction port 15.

As shown in FIGS. 2 and 3, the communication portion 13a is formed along an inner circumferential surface of the pump accommodating concave portion 10a from the portion where the first suction port 14 opens to the portion where the second suction port 15 opens. In a state in which the vane pump 100 is mounted on the fluid hydraulic apparatus, etc., the communication portion 13a is provided so as to be positioned below the horizontal line H extending through the rotation center C of the rotor 2. As described above, the communication portion 13a functions as a flow path for guiding the working oil that has flowed into the communication portion 13a from the connection portion 12b to the second suction port 15, and at the same time, the communication portion 13a also functions as a storage chamber for storing the working oil to be sucked into the pump chambers 6 through the first suction port 14 and the second suction port 15. In other words, because the working oil is sucked into the first suction port 14 and the second suction port 15 through the communication portion 13a functioning as the storage chamber, it is possible to reduce the suction resistance compared to a case in which the working oil is sucked from a simple supply passage.

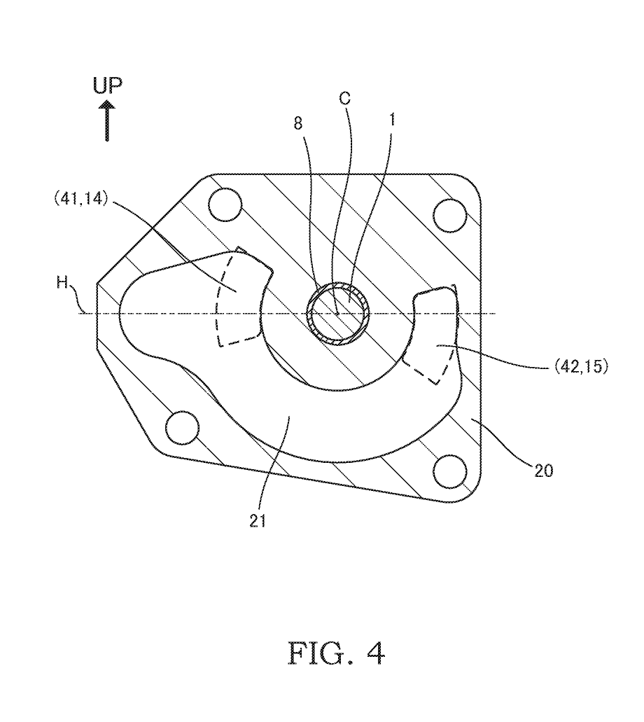

On the side of the surface of the pump cover 20 with which the pump body 10 is brought in to contact, a sub-suction pressure chamber 21 that is in communication with the suction pressure chamber 13 is formed so as to have a concave shape. The sub-suction pressure chamber 21 functions as, together with the suction pressure chamber 13, the storage chamber for storing the working oil to be sucked into the pump chambers 6. In addition, as shown in FIG. 4, the sub-suction pressure chamber 21 is formed so as to extend over the portion that opposes to the first suction cut-out portion 41 and the second suction cut-out portion 42 of the cover-side side plate 40. Therefore, the working oil is supplied to the first suction port 14 and the second suction port 15 through the suction pressure chamber 13 from the outer side in the radial direction, and the working oil is supplied through the sub-suction pressure chamber 21 from the axial direction.

The vane pump 100 further includes a discharge passage 17 that has a discharge opening end 17a opening at the outer surface of the pump body 10 and the high-pressure chamber 16 that is in communication with the discharge passage 17. The high-pressure chamber 16 is an annular space formed on the bottom surface side of the pump accommodating concave portion 10a of the pump body 10, and is defined by the pump body 10 and the body-side side plate 30. The discharge opening end 17a is connected to the one end of a supply pipe 71, and the other end of the supply pipe 71 is connected to a fluid hydraulic apparatus 70 provided at outside of the vane pump 100. In a state in which the vane pump 100 is mounted on the fluid hydraulic apparatus, etc., the discharge opening end 17a is provided so as to be positioned above the first suction port 14 and the second suction port 15.

Next, action of the vane pump 100 will be described.

As the driving shaft 1 is rotationally driven by motive force from a driving device such as the engine (not shown), etc., the rotor 2 is rotated in the direction shown by an arrow in FIG. 2. As the rotor 2 is rotated, the pump chambers 6 located in the suction regions are expanded. With such a configuration, as shown by the arrows in FIG. 2, the working oil in the tank 60 is sucked into the pump chambers 6 through the suction pipe 61, the suction passage 12, the suction pressure chamber 13, the first suction port 14, and the second suction port 15.

In addition, the pump chambers 6 located in the discharge regions are contracted as the rotor 2 is rotated. With such a configuration, as shown by an arrow in FIG. 1, the working oil in the pump chambers 6 is discharged to the high-pressure chamber 16 through the discharge ports 31. The working oil that has been discharged to the high-pressure chamber 16 is supplied to the outside fluid hydraulic apparatus 70 through the discharge passage 17 and the supply pipe 71. With the vane pump 100, as the rotor 2 completes a full rotation, the respective pump chambers 6 repeat the suction and discharge of the working oil twice.

A part of the working oil that has been discharged to the high-pressure chamber 16 is supplied to the back pressure chambers 5 through a passage (not shown) and pushes the base-end portions 3b of the vanes 3 towards the inner circumference cam face 4a. Therefore, the vanes 3 are biased in the direction in which the vanes 3 project out from the slits 2a by the fluid pressure in the back pressure chambers 5 pushing the base-end portions 3b and by the centrifugal force that is caused by the rotation of the rotor 2. With such a configuration, because the rotor 2 is rotated while the tip-end portions 3a of the vanes 3 are brought into sliding contact with the inner circumference cam face 4a of the cam ring 4, the working oil in the pump chambers 6 is discharged from the discharge ports 31 without leaking out from between the tip-end portions 3a of the vanes 3 and the inner circumference cam face 4a of the cam ring 4.

When the vane pump 100 is stopped, because suction pressure is not generated in the pump chambers 6, movement of the working oil from the tank 60 to the vane pump 100 is stopped, and thereby, the discharge of the working oil from the pump chambers 6 to the high-pressure chamber 16 is also stopped. When driving of the fluid hydraulic apparatus 70 or the engine is started again, driving of the vane pump 100 is also started again.

Here, in a state in which the vane pump 100 is mounted on the fluid hydraulic apparatus, etc., if the suction opening end 12a of the suction passage 12 that is the connection portion between the tank 60 and the vane pump 100 is provided at the position lower than the positions of the suction pressure chamber 13, the first suction port 14 and the second suction port 15 that guide the working oil to the pump chambers 6, the working oil in the vane pump 100 returns to the tank 60 through the suction passage 12 when the vane pump 100 is stopped. As described above, if driving of the vane pump 100 is started again when the vane pump 100 is not filled with the working oil, it is necessary to fill the passages from the tank 60 to the pump chambers 6 with the working oil first, and therefore, it takes long time to discharge the working oil from the pump chambers 6. As a result, there is a risk in that a buildup of the discharge pressure is delayed.

In this embodiment, in a state in which the vane pump 100 is mounted on the fluid hydraulic apparatus, etc., the suction opening end 12a of the suction passage 12 is provided at the position higher than those of the first suction port 14, the second suction port 15, and the suction pressure chamber 13. Thus, even when the vane pump 100 is stopped, the working oil in the vane pump 100 is prevented from returning to the tank 60 through the suction passage 12 and remains in the vane pump 100. In particular, the working oil is more easily to be stored in the suction pressure chamber 13 and the sub-suction pressure chamber 21 that are provided below the horizontal line H extending through the rotation center C of the rotor 2. As described above, when driving of the vane pump 100 is started again in a state in which the working oil is stored in the vane pump 100, it does not take long time until the working oil is discharged from the pump chambers 6. As a result, it is possible to improve the buildup of the discharge pressure. In other words, because the above-mentioned advantage can be afforded as long as the suction pressure chamber 13 and the sub-suction pressure chamber 21 are arranged at the positions lower than that of the suction opening end 12a of the suction passage 12 in a state in which the vane pump 100 is mounted on the fluid hydraulic apparatus, etc., it suffices to have the configuration in which, for example, the suction pressure chamber 13 and the sub-suction pressure chamber 21 are provided below the horizontal line H extending through the rotation center C of the rotor 2, and the suction opening end 12a is provided above the horizontal line H extending through the rotation center C of the rotor 2.

In addition, in this embodiment, in a state in which the vane pump 100 is mounted on the fluid hydraulic apparatus, etc., the discharge opening end 17a of the discharge passage 17 is also provided at the position higher than those of the first suction port 14, the second suction port 15, and the suction pressure chamber 13. Thus, even when the vane pump 100 is stopped, the working oil in the vane pump 100 is prevented from flowing out to the fluid hydraulic apparatus 70 through the discharge passage 17 and remains in the vane pump 100.

In addition, in a state in which the vane pump 100 is mounted on the fluid hydraulic apparatus, etc., as long as either one of the first suction port 14 or the second suction port 15 is arranged downwards, when driving of the vane pump 100 is started again, it is believed that the working oil is guided to the pump chambers 6 through the suction port arranged at the lower position, and the working oil is discharged at earlier timing. However, in this case, because it takes long time until the working oil is guided to the pump chambers 6 through the suction port arranged at the higher position, as a result, there is a risk in that the buildup of the discharge pressure in the vane pump 100 is delayed.

In contrast, in this embodiment, in a state in which the vane pump 100 is mounted on the fluid hydraulic apparatus, etc., the first suction port 14 and the second suction port 15 are arranged on the horizontal line H extending through the rotation center C of the rotor 2. Thus, when driving of the vane pump 100 is started again, the working oil is guided to the pump chambers 6 from the suction ports of both of the first suction port 14 and the second suction port 15. As a result, it is possible to improve the buildup of the discharge pressure.

Further in this embodiment, in a state in which the vane pump 100 is mounted on the fluid hydraulic apparatus, etc., the first suction port 14, which guides the working oil to the pump chambers 6 that are contracted below the rotation center C of the rotor 2 among the pump chambers 6, is arranged at a position close to the suction passage 12. In this configuration, when the vane pump 100 is stopped, because the discharge pressure is lowered, the pressure in the back pressure chambers 5 is also lowered, and the vanes 3 are displaced by their own weight. In other words, the vanes 3 positioned below the rotation center C of the rotor 2 become a state in which the vanes 3 have been displaced towards the inner circumference cam face 4a by their own weight. Thus, a state in which the working oil is more easily be discharged from the pump chambers 6 positioned below the rotation center C of the rotor 2 than from the pump chambers 6 positioned above the rotation center C of the rotor 2 is achieved. In other words, in this embodiment, among the first suction port 14 and the second suction port 15, it is possible to supply the working oil with priority to the first suction port 14 that is in communication with the pump chambers 6 that are in a state in which the working oil can be discharged easily. In addition, in this embodiment, because the configuration does not have branched passages for guiding the working oil from the suction passage 12 to the first suction port 14 and the second suction port 15, it is possible to simplify the flow path, and at the same time, it is possible to reduce the suction resistance along the flow path directed to the first suction port 14 that is arranged close to the suction passage 12.

As described above, according to the above-mentioned embodiment, it is possible to improve the buildup of the discharge pressure when driving of the vane pump 100 is started again.

Configurations, operations, and effects of the embodiment of the present invention configured as described above will be collectively described below.

The vane pump 100 includes: the rotor 2 that is driven rotationally; the plurality of vanes 3 that are inserted into the rotor 2 in a freely slidable manner; the cam ring 4 with which the tip-end portions 3a of the vanes 3 are brought into sliding contact with the rotation of the rotor 2; the pump body 10 that accommodates the cam ring 4; the pump cover 20 that seals the pump body 10; the pump chambers 6 that are defined between the vanes 3 at adjacent positions and the cam ring 4; the suction ports 14 and 15 that guide the working oil to the pump chambers 6; the suction pressure chamber 13 that is communicated with the suction ports 14 and 15 and that stores the working oil; and the suction passage 12 having the connection portion 12b that is connected to the suction pressure chamber 13 and the suction opening end 12a that opens at the outer surface of the pump body 10, and the suction pressure chamber 13 is provided below the suction opening end 12a of the suction passage 12 in a state in which the vane pump 100 is mounted.

With such a configuration, in a state in which the vane pump 100 is mounted on the fluid hydraulic apparatus, etc., the suction pressure chamber 13 is provided below the suction opening end 12a of the suction passage 12. Thus, even if the vane pump 100 is stopped, the working oil in the vane pump 100 remains in the suction pressure chamber 13 and does not returns to the tank 60 through the suction passage 12. As described above, if driving of the vane pump 100 is started again in a state in which the working oil is stored in the vane pump 100, it does not take long time until the working oil is discharged from the pump chambers 6. As a result, it is possible to improve the buildup of the discharge pressure.

In addition, the suction ports 14 and 15 include the first suction port 14 and the second suction port 15 that are provided so as to be opposed to each other with respect to the rotation center C of the rotor 2, and the suction pressure chamber 13 has the communication portion 13a through which the first suction port 14 communicates with the second suction port 15.

With such a configuration, the communication portion 13a through which the first suction port 14 communicates with the second suction port 15 is provided as a part of the suction pressure chamber 13. In other words, when the vane pump 100 is stopped, the working oil is stored in the communication portion 13a through which the first suction port 14 communicates with the second suction port 15. When driving of the vane pump 100 is started again, the working oil stored in the communication portion 13a is promptly supplied to at least one of the first suction port 14 and the second suction port 15. As a result, it does not take long time until the working oil is discharged from the pump chambers 6, and it is possible to improve the buildup of the discharge pressure without taking time.

In addition, in a state in which the vane pump 100 is mounted, the first suction port 14 and the second suction port 15 are arranged on the horizontal line H extending through the rotation center C of the rotor 2.

With such a configuration, the first suction port 14 and the second suction port 15 are arranged on the horizontal line H extending through the rotation center C of the rotor 2 in a state in which the vane pump 100 is mounted on the fluid hydraulic apparatus, etc. Thus, when driving of the vane pump 100 is started again, the working oil is guided to the pump chambers 6 from both of the first suction port 14 and the second suction port 15 substantially simultaneously. As a result, compared with a case in which only one of the suction ports is arranged at a position lower than the other, it is possible to improve the buildup of the discharge pressure.

In addition, in a state in which the vane pump 100 is mounted, the first suction port 14 guides the working oil to the pump chambers 6 that are contracted below the rotation center C of the rotor 2 among the pump chambers 6, the second suction port 15 guides the working oil to the pump chambers 6 that are contracted above the rotation center C of the rotor 2 among the pump chambers 6, and the first suction port 14 communicates with the suction pressure chamber 13 at a portion closer to the connection portion 12b than the second suction port 15.

With such a configuration, in a state in which the vane pump 100 is mounted on the fluid hydraulic apparatus, etc., the first suction port 14, which guides the working oil to the pump chambers 6 that are contracted below the rotation center C of the rotor 2 among the pump chambers 6, is arranged at a position close to the connection portion 12b, in other words, at a position close to the suction passage 12. In a state in which the vane pump 100 is stopped, because the vanes 3 positioned below the rotation center C of the rotor 2 are in a state in which the vanes 3 are displaced towards the inner circumference cam face 4a by their own weight, a state in which the working oil is more easily to be discharged from the pump chambers 6 positioned below the rotation center C of the rotor 2 than from the pump chambers 6 positioned above the rotation center C of the rotor 2 is established. In other words, with such a configuration, among the first suction port 14 and the second suction port 15, it is possible to supply the working oil with priority to the first suction port 14 that is in communication with the pump chambers 6 that are in a state in which the working oil can be discharged easily. Thus, it is possible to further improve the buildup of the discharge pressure of the vane pump 100. In addition, with such a configuration, because the branched passages for respectively guiding the working oil from the suction passage 12 to the first suction port 14 and the second suction port 15 are not provided, it is possible to simplify the flow path, and at the same time, it is possible to reduce the suction resistance along the flow path directed to the first suction port 14 that is arranged close to the suction passage 12.

In addition, the suction pressure chambers 13 and 21 are provided so as to extend over the pump body 10 and the pump cover 20.

With such a configuration, the suction pressure chambers 13 and 21 are provided so as to extend over the pump body 10 and the pump cover 20. As described above, because a sufficient volume is ensured for the suction pressure chambers 13 and 21 for storing the working oil, it is possible to store a large amount of the working oil in the vane pump 100 even when the vane pump 100 is stopped. When driving of the vane pump 100 is started again in a state in which a large amount of the working oil is stored in the vane pump 100, it does not take long time until the working oil is discharged from the pump chambers 6. As a result, it is possible to improve the buildup of the discharge pressure. Furthermore, by ensuring a sufficient volume of the suction pressure chambers 13 and 21 that are oil passages for guiding the working oil to the first suction port 14 and the second suction port 15, it is possible to suppress occurrence of cavitation at each of the suction ports 14 and 15.

In addition, the vane pump 100 further includes: the discharge ports 31 to which the working oil to be discharged from the pump chambers 6 is guided; the high-pressure chamber 16 that is in communication with the discharge ports 31 and that stores the pressurized working oil; and the discharge passage 17 that has the discharge opening end 17a opening at the outer surface of the pump body 10 and that is in communication with the high-pressure chamber 16, and the suction pressure chamber 13 is provided below the discharge opening end 17a of the discharge passage 17 in a state in which the vane pump 100 is mounted.

With such a configuration, in a state in which the vane pump 100 is mounted on the fluid hydraulic apparatus, etc., the suction pressure chamber 13 is provided below the discharge opening end 17a of the discharge passage 17. Thus, even when the vane pump 100 is stopped, the working oil in the vane pump 100 remains in the suction pressure chamber 13 and does not flow out to the fluid hydraulic apparatus 70 through the discharge passage 17. As described above, when driving of the vane pump 100 is started again in a state in which the working oil is stored in the vane pump 100, it does not take long time until the working oil is discharged from the pump chambers 6. As a result, it is possible to improve the buildup of the discharge pressure.

Embodiments of the present invention were described above, but the above embodiments are merely examples of applications of the present invention, and the technical scope of the present invention is not limited to the specific constitutions of the above embodiments.

For example, the vane pump 100 is not limited to that arranged outside the tank 60, and the vane pump 100 may be arranged within the tank 60 and immersed in the working oil.

In addition, the vane pump 100 is not limited to a pump of a type in which the discharge capacity (pump displacement volume) is constant, and the vane pump 100 may be a pump of a variable displacement type in which the discharge capacity thereof can be changed by displacing the cam ring.

This application claims priority based on Japanese Patent Application No. 2015-206951 filed with the Japan Patent Office on Oct. 21, 2015, the entire contents of which are incorporated into this specification.

1. A vane pump used as a fluid pressure source, comprising:
a rotor configured to be driven rotationally;
a plurality of vanes inserted into the rotor in a freely slidable manner;
a cam ring with which tip-end portions of the vanes are brought into sliding contact with rotation of the rotor;
a pump body configured to accommodate the cam ring;
a pump cover configured to seal the pump body;
pump chambers defined between the vanes at adjacent positions and the cam ring;
a suction port configured to guide working fluid to the pump chambers;
a storage chamber configured to store the working fluid, the storage chamber being configured to communicate with the suction port; and
a suction passage configured to have a connection portion and a suction opening end, the connection portion being connected to the storage chamber and the suction opening end being configured to open at an outer surface of the pump body; wherein
the storage chamber is provided below the suction opening end of the suction passage in a state in which the vane pump is mounted.

2. The vane pump according to claim 1, wherein
the suction port has a first suction port and a second suction port provided so as to be opposed to each other with respect to a rotation center of the rotor, and
the storage chamber has a communication portion with which the first suction port is communicated with the second suction port.

3. The vane pump according to claim 2, wherein
the first suction port and the second suction port are arranged on a horizontal line extending through the rotation center in a state in which the vane pump is mounted.

4. The vane pump according to claim 2, wherein
in a state in which the vane pump is mounted:
the first suction port is configured to guide the working fluid to the pump chambers, the pump chambers being those contracted below the rotation center among the pump chambers;
the second suction port is configured to guide the working fluid to the pump chambers, the pump chambers being those contracted above the rotation center among the pump chambers; and
the first suction port is configured to communicate with the storage chamber at a portion closer to the connection portion than the second suction port.

5. The vane pump according to claim 1, wherein
the storage chamber is provided so as to extend over the pump body and the pump cover.

6. The vane pump according to claim 1 further including:
a discharge port to which the working fluid to be discharged from the pump chambers is guided;
a high-pressure chamber configured to store the pressurized working fluid, the high-pressure chamber being configured to communicate with the discharge port; and
a discharge passage configured to have a discharge opening end and to communicate with the high-pressure chamber, the discharge opening end being configured to open at the outer surface of the pump body; wherein
the storage chamber is provided below the discharge opening end of the discharge passage in a state in which the vane pump is mounted.
